(19) United States
(12) Patent Application Publication
(10) Pub. No.: US 2012/0057212 A1
(43) Pub. Date: Mar. 8, 2012

(54) Sheet conveying device, original conveying device, sheet scanning device, and image forming apparatus

(75) Inventors: Hideki Tobinaga, Kanagawa (JP); Norio Kimura, Kanagawa (JP); Atsushi Kanaya, Kanagawa (JP); Michitaka Suzuki, Kanagawa (JP); Yoshito Suzuki, Kanagawa (JP); Kenichiro Morita, Kanagawa (JP); Shinya Kitaoka, Kanagawa (JP); Mamoru Kambayashi, Tokyo (JP)

(73) Assignee: Ricoh Company, Limited, Tokyo (JP)

(21) Appl. No.: 13/137,625

(22) Filed: Aug. 30, 2011

(30) Foreign Application Priority Data
Sep. 3, 2010 (JP) 2010-198354

(51) Int. Cl. H04N 1/04; B65H 3/06

(52) U.S. Cl. 358/498; 271/118

(57) ABSTRACT

A sheet conveying device includes: a sheet loading unit; a pick-up roller that draws a sheet from a stack of sheets set on the sheet loading unit; a moving unit that causes the pick-up roller to separate from or press against a top-surface of the sheet; a feeding member; a prevention member that prevents an original from being conveyed by the feeding member; a separation unit that separates and conveys each sheet, which is fed by the pick-up roller, to downstream in a conveying direction; and a detection unit that detects whether the original moves, the detection unit being arranged in a position near the separation unit or in upstream of the separation unit in the conveying direction. At least when the stack of sheets is being set on the sheet loading unit, the detection unit is not in contact with the sheet.

### CROSS-REFERENCE TO RELATED APPLICATIONS

The present application claims priority to and incorporates by reference the entire contents of Japanese Patent Application No. 2010-198354 filed in Japan on Sep. 3, 2010.

### BACKGROUND OF THE INVENTION

1. Field of the Invention

The present invention relates to a sheet conveying device that conveys a sheet member, an original conveying device that uses the sheet conveying device, a sheet scanning device that uses the original conveying device, and an image forming apparatus.

2. Description of the Related Art

In a device, known as a sheet-through original conveying device, in which a fixed scanning unit exposes an original, which is a sheet member, to a light at a predetermined rate in scanning the original, it is necessary to maintain the interval between successive originals (hereinafter, “sheet interval”) within a predetermined range to secure a certain degree of productivity. A technology has been already known in which a detection unit, such as a sensor, detects, in order to determine timing for feeding the next original, that the trailing edge of the preceding original has passed through a predetermined position and a detection signal triggers to feed the next original.

A specific description will be given below with reference to FIGS. 13A to 13C. As illustrated in FIG. 13A, an original conveying device includes a pick-up roller 7. The pick-up roller 7 moves down and thus an original 1P in a bundle 1 of originals is conveyed to a separation unit B formed by a feeding belt 9 and a reverse roller 10. After the leading edge of the original reaches a pull-out roller (not illustrated) that is arranged downstream of a separator B in the feeding direction, the pick-up roller 7, having finished the separating operation, moves up to be separated from the original 1P as illustrated in FIG. 13B. The original is further conveyed and when a trailing edge 1Pa passes through a separation sensor S3 that is arranged between the pull-out roller and the separation unit B, the pick-up roller 7 starts to move down in preparing for feeding the next original. After the pick-up roller 7 has securely gripped the next original, the pick-up roller 7 starts to rotate and the next original is fed. The next original is fed at a linear speed larger than the scanning speed of the scanning unit and the original approaches the trailing edge of the preceding original, so that the sheet interval between the preceding original and the next original is shortened.

However, when high-speed original scanning is performed, if the pick-up roller 7 starts to move down in accordance with the position of the trailing edge of the preceding original, as described above, the time necessary for a pick-up to move down may lead to a time lag. If the pick-up roller is started to move down after the trailing edge 1Pa of the original illustrated in FIG. 13C passes through the separation sensor S3, it may take several ten milliseconds. Particularly when the number of originals that are scanned per minute far exceeds 100, because the time period required for a sheet interval is very short even for scanning with an ordinary scanning speed, there is a problem in that the feeding speed of the next original may not keep up with a predetermined speed. Japanese Patent Application Laid-open No. H9-301573 and Japanese Patent Application Laid-open No. H10-167494 disclose a configuration in which the trailing edge of an original is detected in the upstream of the original separation unit in the original feeding direction so as to detect the trailing edge of the next original early and thus to improve productivity.

In Japanese Patent Application Laid-open No. H9-301573 and Japanese Patent Application Laid-open No. H10-167494, the detection unit that detects the trailing edge of an original is arranged in the upstream of the original separation unit in the original feeding direction and thus the trailing edge is detected early, which is advantageous for high productivity of originals. However, in Japanese Patent Application Laid-open No. H9-301573 and Japanese Patent Application Laid-open No. H10-167494, the detection unit is arranged on an original table and thus the detection unit is in contact with the original that is set on the original table, leading to a problem in that the accuracy in setting an original is significantly reduced. The original conveying device is often used with a large number of originals set thereon and may cause problems. For example, if the detection unit is configured to be in contact with each original, originals may be caught by the detection unit when originals are set on the original table. In addition, the configuration of the original conveying device may impose a limitation on the number of originals. However, Japanese Patent Application Laid-open No. H9-301573 and Japanese Patent Application Laid-open No. H10-167494 do not provide any clues to solve the problems. In other words, Japanese Patent Application Laid-open No. H9-301573 and Japanese Patent Application Laid-open No. H10-167494 do not provide any means to achieve high operability and high productivity by means of controlling the sheet interval.

The present invention provides a sheet conveying device that keeps high productivity by keeping the feed timing of the trailing edge of an original early and that has excellent operability, an original conveying device, a sheet scanning device, and an image forming apparatus.

### SUMMARY OF THE INVENTION

It is an object of the present invention to at least partially solve the problems in the conventional technology.

According to an aspect of the present invention, there is provided a sheet conveying device including: a sheet loading unit; a pick-up roller that draws a sheet from a stack of sheets set on the sheet loading unit; a moving unit that causes the pick-up roller to separate from or press against a top surface of the sheet; a feeding member; a prevention member that prevents an original from being conveyed by the feeding member; a separation unit that separates and conveys each sheet, which is fed by the pick-up roller, to downstream in a conveying direction; and a detection unit that detects whether the original moves, the detection unit being arranged in a position near the separation unit or in upstream of the separation unit in the conveying direction. At least when the stack of sheets is being set on the sheet loading unit, the detection unit is not in contact with the sheet.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram illustrating an entire configuration of an image forming apparatus according to the present invention;

FIG. 2 is an enlarged view of a schematic configuration of a sheet scanning device including an original conveying device that includes a sheet conveying device;

FIG. 3 is a block diagram illustrating a configuration of a control system of the sheet scanning device;

FIG. 4 is an enlarged view of a configuration of a detection unit that is not in contact with a sheet and the units surrounding the detection unit;

FIG. 5 is an enlarged view illustrating how the detection unit is supported and illustrating another configuration of a separation unit;

FIG. 6 is an enlarged view illustrating how the detection unit is supported and illustrating still another configuration of a separation unit;

FIG. 7 is an enlarged cross-sectional view of an example of an optical detection unit;

FIG. 8 is an enlarged view of a separated position (waiting position) of the detection unit;

FIG. 9 is an enlarged view of the detection position of the detection unit;

FIG. 10 is a schematic view of an example of a mechanical detection unit;

FIG. 11 is a flowchart for controlling the movement of the detection unit;

FIG. 12 is an enlarged view illustrating how the detection unit performs detection while it is separated from a sheet member; and

FIGS. 13A to 13C contain diagrams of a configuration of a main part of a conventional sheet conveying device, where FIG. 13A illustrates that a pick-up roller sends out a preceding original, FIG. 13B illustrates the pick-up roller that has sent the preceding original, and FIG. 13C illustrates that the pick-up roller sends out the next original.

### DETAILED DESCRIPTION OF THE PREFERRED EMBODIMENTS

Embodiments of the present invention will be described below with reference to the accompanying drawings. First, a schematic configuration of an image forming apparatus will be described and then main parts of the present invention will be described. In each of the embodiments, elements that are common to those in the conventional configuration are provided with the same reference numerals. The descriptions provided in each of the embodiments are the embodying examples and the present invention is not limited to those descriptions.

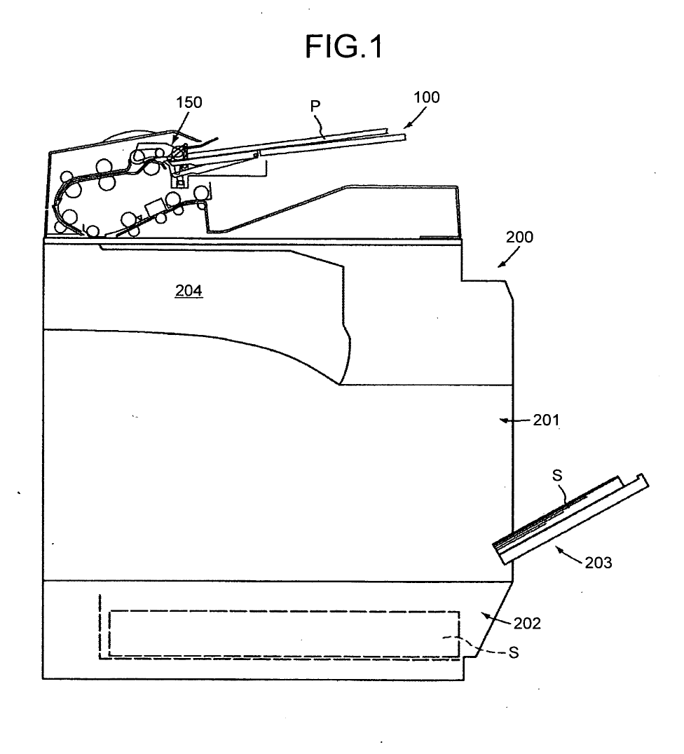

An image forming apparatus 200 in FIG. 1 includes an image forming unit 201 at a central portion of the body. The image forming apparatus 200 includes a feeding unit 202 below the image forming unit 201. The feeding unit 202 stores therein a plurality of sheets of paper functioning as recording media that are to be fed to the image forming unit 201. An automatic document feeder 100 feeding an original that functions as a sheet member and scanning an image on the original to function as a sheet member scanning device is arranged above the image forming unit 201. A bypass feeding unit 203 is arranged on a side of the image forming unit 201. The reference numeral 204 denotes a discharge unit.

The image forming method performed by the image forming unit 201 may be an electrophotographic method, an ink-jet method, a stencil method in which a plate is formed for printing, or the like. An image forming apparatus 200 may be a multi-function peripheral that includes any one or more functions of a copier, a printer, or a facsimile machine.

The automatic document feeder 100 will be described below.

The characteristics of the automatic document feeder 100 can be summarized as follows. In feeding originals while the originals are sequentially conveyed, the trailing edge of a preceding original is made to be detected as early as possible and a detection unit for detecting the position of the trailing edge is not in contact with the original, so that originals can be set without losing the setting capability of originals possessed by the detection unit. When the detection unit also has a function of detecting the movement of a preceding original, the detection unit can detect whether there is a preceding original even when one original overlaps with another original; therefore, the flexibility in arranging the detection unit to detect the preceding original is improved and high-speed production can be performed with a more compact configuration.

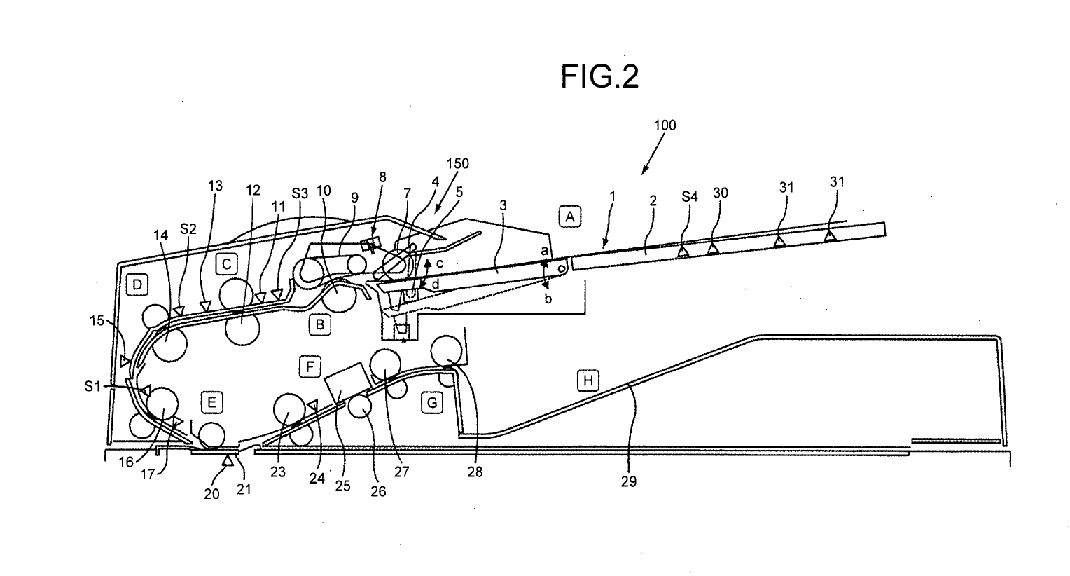

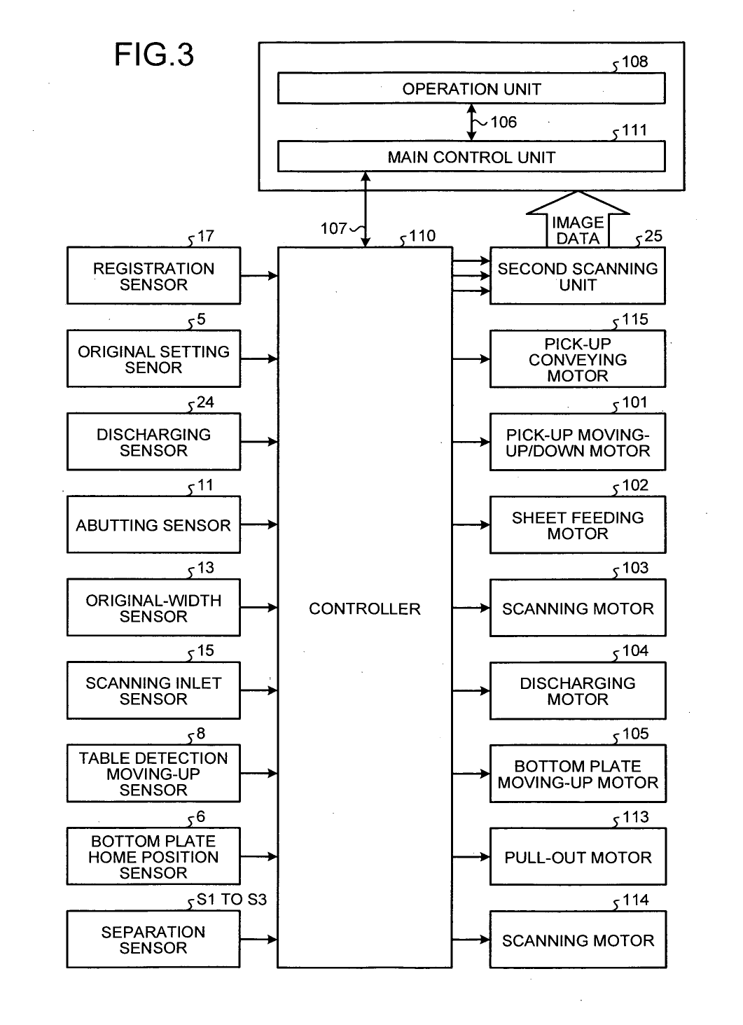

The automatic document feeder 100 illustrated in FIG. 2 is a device that conveys the original 1P to be scanned to a fixed scanning unit and scans an image on the original 1P while conveying the original at a predetermined speed. The automatic document feeder 100 is referred to as “ADF 100” hereafter. A basic configuration, operations, and effects of the ADF 100 will be described below with reference to the cross-sectional view of the ADF 100 in FIG. 2 and the control block diagram in FIG. 3.

The ADF 100 includes an original setting unit A that functions as a sheet loading unit and on which a stack of originals to be scanned (which is referred to as “original stack 1” hereinafter) is set; a separation feeding unit B that functions as a separation unit and that separates each original 1P from the set original stack 1 and conveys the original 1P to downstream; a registration unit C with which the conveyed original 1P is firstly abutted to be aligned therein and then is drawn to be conveyed; a turning unit D that turns over the conveyed original 1P and conveys the original 1P with the surface of the original facing the scanning side (i.e., facing downward); a first scanning conveying unit E that scans the front surface of the original 1P from below through a contact glass 21; a second scanning conveying unit F that scans an image on the back surface of the scanned original 1P; a discharge unit G that discharges the original 1P of which both surfaces have been scanned to the outside of the apparatus; a stacking unit H that stacks and stores scanned originals 1P; drivers from a pick-up moving up/down motor 101 to an operation unit 108 of a main body in FIG. 3 that drive the conveying operations; and a controller 110 that controls the operations. The original setting unit A, the separation feeding unit B, and the registration unit C configure a sheet conveying device 150. In this embodiment, because the sheet conveying device 150 conveys the original 1P as a sheet member, the sheet conveying device 150 also functions as an original conveying device.

The original stack 1 to be scanned is set on an original table 2, which includes a movable original table 3, with the surfaces of the originals being set to be facing upward. Both sides of the original stack 1 in the width direction are aligned with the direction perpendicular to the conveying direction by a side guide (not illustrated). The setting of originals 1P is detected by a setting feeler 4 and a setting sensor 5, and an interface (I/F) 107 transmits the detection result to a control unit 111 of the main body. Furthermore, the approximate length of the original 1P in the conveying direction is determined by any one of original length detection sensors 30 and 31, which are provided on the surface of the original table (a reflective sensor or an actuator-type sensor that can detect even one piece of original is used). These sensors are arranged such that at least the height or width of the originals of the uniform size can be determined.

The movable original table 3 is configured to be moved by a bottom plate moving-up motor 105 in the upward and downward directions denoted, respectively, by a and b in FIG. 2. Once the set feeler 4 and the setting sensor 5 detect that the original stack 1 is set, the controller 110 causes the bottom plate moving-up motor 105 to rotate in the normal direction so as to move up the movable original table 3 until the top surface of the original stack 1 makes contact with the pick-up roller 7. The movable original table 3 and the bottom plate moving-up motor 105 configure a unit for moving up and down an original table and also configure a moving unit that causes the pick-up roller 7 to separate from or press against the top surface of the original stack 1.

The pick-up roller 7 is configured to move by the pick-up moving-up/down motor 101 via a cam system in the directions indicated by the reference symbols c and d in FIG. 2. The pick-up roller 7 is also configured to be pushed up, when the movable original table 3 moves up, by the top surface of the original on the movable original table 3 to move in the c direction, so that a table moving-up detection sensor 8 can detect the upper limit that the pick-up roller 7 can reach. The pick-up roller 7 has a function of drawing a piece of the original 1P from the original stack 1, which is set in the original setting unit A.

Once a print key is pushed in the operation unit 108 of the main body and an original feeding signal is transmitted from the control unit 111 of the main body, via the I/F 107, to the controller 110 that functions as a control unit of the ADF, a pick-up and conveyance motor 115 drives to rotate the pick-up roller 7 and thus the pick-up roller 7 picks up several pieces of the original 1P (ideally one piece of the original 1P) from the original table 2. The rotational direction is the direction in which the top piece of the original 1P is conveyed to the feeding port. The pick-up moving-up/down motor 101 and the movable original table 3 configure a pick-up moving-up/down unit and also configure a moving unit that causes the pick-up roller 7 to separate from or press against the top surface of the original stack 1.

The present embodiment includes, as the moving unit, both of the original table moving-up/down unit and the pick-up moving-up/down unit. Alternatively, the moving unit that causes the pick-up roller 7 to separate from or press against an original may be configured of any one of the original table moving-up/down unit and the pick-up moving-up/down unit only.

Normal rotation of a feeding motor 102 drives the feeding belt 9 in the feeding direction, whereas the normal rotation of the feeding motor 102 drives to rotate the reverse roller 10 in the direction opposite to the feeding direction; thus, the top piece of the original 1P is separated from the other pieces of the originals 1P under the top piece of the original 1P so that only the top piece of the original 1P can be fed.

More specifically, the reverse roller 10 makes contact with the feeding belt 9 with a predetermined pressure. When the reverse roller 10 is in direct contact with the feeding belt 9, or when the reverse roller 10 is in contact with the feeding belt 9 with one piece of original interposed between the reverse roller 10 and the feeding belt 9, the reverse roller 10 rotates counterclockwise in association with the rotation of the feeding belt 9. The reverse roller 10 is set such that, when two or more pieces of the originals 1P enter a gap between the feeding belt 9 and the reverse roller 10, a torque caused by the force that is generated in association with the rotation of the feeding belt 9 becomes weaker than the torque of the torque limiter. Accordingly, the reverse roller 10 rotates clockwise, i.e., in a normal driving direction, and functions to push back an extra piece of the original 1P so as to prevent a plurality of pieces of the original 1P from being conveyed together.

One piece of the original 1P that is separated by the action of the feeding belt 9 and the reverse roller 10 is further conveyed by the feeding belt 9, which functions as the feeding member, or by a feeding roller 309, which will be described below, and thus the leading edge of the original 1P is sensed by an abutting sensor 11 that is arranged in the original conveying direction. A pair of pull-out rollers 12 that functions as a stopping member to stop conveying an original is arranged immediately after the abutting sensor 11. The original 1P that has moved forward from the abutting sensor 11 abuts the pull-out rollers 12 not in operation. The original 1P is then conveyed by the predetermined distance after being detected by the abutting sensor 11. Accordingly, by stopping the feeding motor 102 while the original P1 is pressed against the pull-out rollers 12 with a predetermined deflection, driving of the feeding belt 9 stops while the original 1P is held by the pull-out rollers 12.

By rotating the pick-up moving-up/down motor 101, the pick-up roller 7 is caused to move away from the top surface of the original. The original 1P is transferred by the conveying force of the feeding belt 9 only, and the leading edge of the original enters the nip between a pair of upper and lower rollers configuring the pull-out rollers 12, and thus the leading edge is adjusted (skew correction).

The pull-out rollers 12 have a skew correction function. The pull-out rollers 12 also have a function of rollers to convey the original 1P, on which the skew correction is performed after the separation, to intermediate rollers 14. The pull-out rollers 12 are driven by the reverse rotation of a pull-out motor 113. Because the pull-out rollers 12 are driven by the pull-out motor 113, which is an independent driving unit, the start-up time and the ending time of the motor can be shortened to improve productivity.

A plurality of original width sensors 13 are arranged in the original depth direction between the pull-out rollers 12 and the intermediate rollers 14 to detect the size of the original 1P in the width direction that is perpendicular to the conveying direction of the original 1P having been conveyed by the pull-out rollers 12. The length of the original 1P in the conveying direction is detected, on the basis of motor pulses, by reading the leading edge and the trailing edge of the original 1P with the use of the abutting sensor 11.

In the embodiment, the pull-out rollers 12 and the intermediate rollers 14 are driven to convey the original 1P from the registration unit C to the turning unit D. By setting the conveying speed in the registration unit C larger than the conveying speed in the first scanning conveying unit E, the length of time required for the process to send the original 1P to a scanning unit 20 is shortened. Once the leading edge of the original is detected by a scanning inlet sensor 15, which is arranged between the turning unit D and the first scanning conveying unit E, before the leading edge of the original enters the nip between the pair of upper and lower rollers, which configure scanning inlet rollers 16, the original conveying speed starts being reduced to be equal to the scan conveying speed and a scanning inlet motor 114 is driven normally to drive the scanning inlet rollers 16, and a scanning motor 103 is driven normally to drive reading outlet rollers 23 and contact image sensor (CIS) outlet rollers 27. Once a registration sensor 17 detects the leading edge of the original 1P, the original 1P is decelerated in a predetermined conveying distance to be temporarily stopped before reaching the scanning unit 20 while a registration stop signal is transmitted to the control unit 111 of the main body via the I/F 107.

Once the control unit 111 of the main body receives a scanning start signal, the original 1P that has been stopped for registration is accelerated until reaching a predetermined conveying speed before the leading edge of the original arrives at the position where the scanning unit 20 is arranged. At a timing when the leading edge of the original detected using the pulse counting of the scanning inlet motor 114 reaches the scanning unit 20, gate signals indicating an effective image area of a first surface in the sub-scanning direction are transmitted to the control unit 111 of the main body until the trailing edge of the original passes through (goes through) the first scanning unit 20.

When a single-sided original is scanned, the original 1P that has passed through the first scanning conveying unit E is conveyed to the discharge unit G via a second scanning unit 25. Once a discharging sensor 24 detects the leading edge of the original 1P, a discharging motor 104 is driven normally to rotate discharging rollers 28 counterclockwise. Furthermore, in accordance with the pulse counting counted by the discharging motor 104 since when the discharging sensor 24 detects the leading edge of the original 1P, the driving speed of the discharging motor is reduced immediately before the trailing edge 1Pa of the original is discharged from the nip between the pair of upper and lower rollers configuring the discharge rollers 28 so that the original 1P to be discharged to a discharge tray 29 does not pop out of the main body of the apparatus.

When a double-sided original is scanned, after the discharging sensor 24 detects the leading edge of the original, in accordance with the pulse counting of the scanning motor, gate signals indicating an effective image area in a sub-scanning direction are transmitted from a document feeder (DF) controller 110 to the second scanning unit 25 starting when the leading edge of the original reaches the second scanning unit 25 and ending when the trailing edge 1Pa passes through (goes through) the second scanning unit 25. A second read roller 26 suppresses floating of an original 1P in the second scanning unit 25 and also functions as a reference white portion to acquire shading data in the second scanning unit 25. Alternatively, in the present embodiment, a system may be adopted that does not include the second scanning unit 25 and in which the original is reversed or is returned to the first scanning conveying unit E via a switchback conveying path so that the back surface of the original can be scanned. The reference numerals S1 to S4 in FIG. 2 denote sensors.

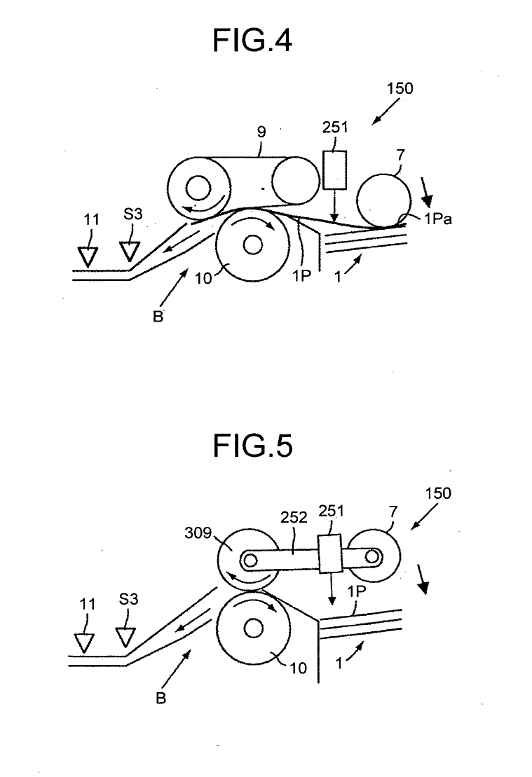

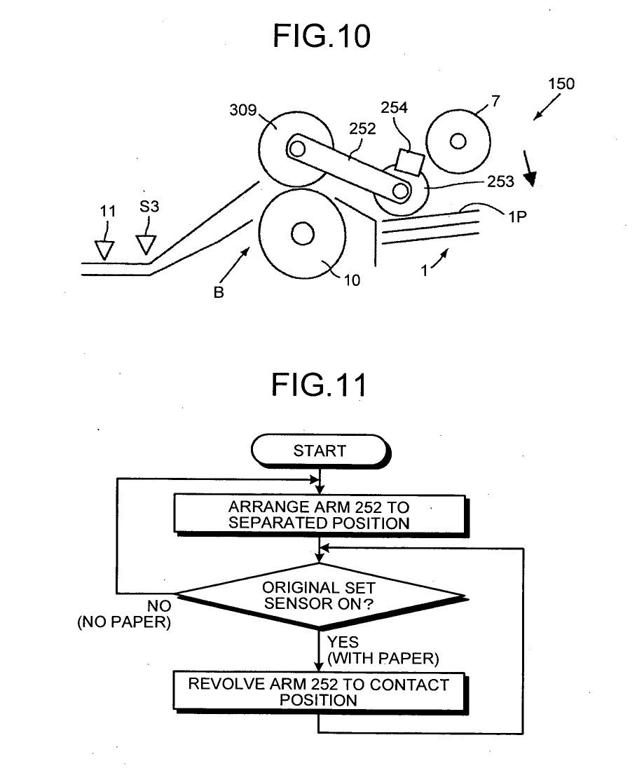

A characteristic configuration of the present invention will be described below. As illustrated in FIG. 4, a sensor 251 detecting, as a detection unit, whether or not the original 1P is moving is arranged near the separation unit B in the upstream in the original conveying direction, i.e., between the separation unit B and the pick-up roller 7. The sensor 251 detecting the movement of the original 1P is arranged above the original stack 1. The sensor 251 may be a sensor having a configuration illustrated in FIG. 7 in which the optical path is changed using an optical system 251B, including a lens and a prism, and light emitted from a light source 251A configured by a popular light-emitting diode (LED) is obliquely applied, in a similar manner to an optical mouse, to the target that is the original 1P, and the light reflected from the original 1P is detected by a sensor 251C to recognize a pattern contained in the unevenness of the original 1P; then, movement of the pattern is calculated to obtain the movement of the original 1P. Another configuration (not illustrated) may be to perform a pattern recognition based on a similar principle as that descried above by using laser light and calculation is performed using an interference pattern. In other words, optical properties of the sensor 251 are used to detect movement of the original 1P. Alternatively, a mechanically-configured sensor 254 may be used, as illustrated in FIG. 10, with a configuration in which a roller 253 is pressed lightly against the original 1P and the sensor 254 detects whether an encoder (not illustrated) arranged coaxially with the roller 253 rotates, thereby detecting whether the original 1P moves.

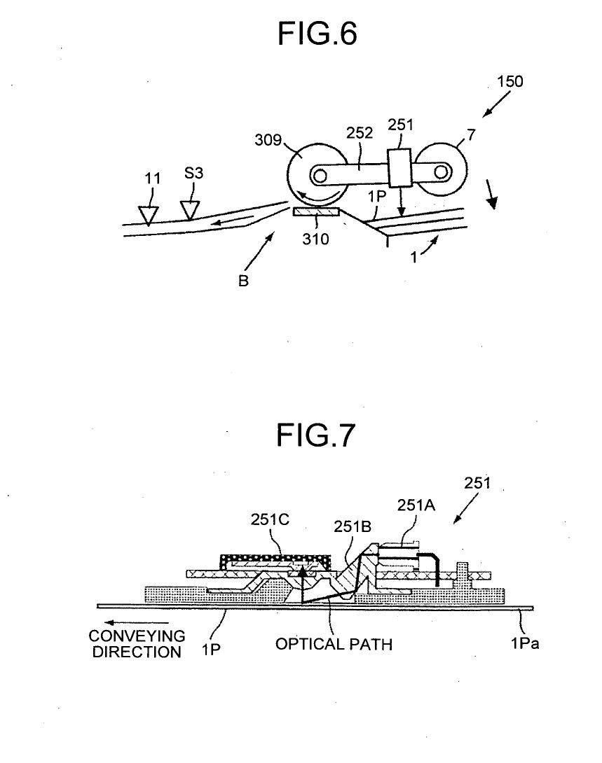

Configuration of the separation unit B in the present embodiment is not limited to a combination of the feeding belt 9 and the reverse roller 10 as illustrated in FIG. 4. The separation unit B may also be configured by a combination of the feeding roller 309 functioning as a feeding member and the reverse roller 10 as illustrated in FIG. 5 (in this case, the reverse roller 10 is not necessarily driven and it is satisfactory if the second and the subsequent originals 1P are prevented from being conveyed) or a combination of the feeding roller 309 and a separation pad 310 as illustrated in FIG. 6.

The sensor 251 in the present embodiment can detect how the original 1P moves even when the sensor is separated from the original 1P to be detected. As illustrated in FIG. 4, the sensor 251 is arranged in a position separated from the surface of the original being conveyed by a certain amount of distance.

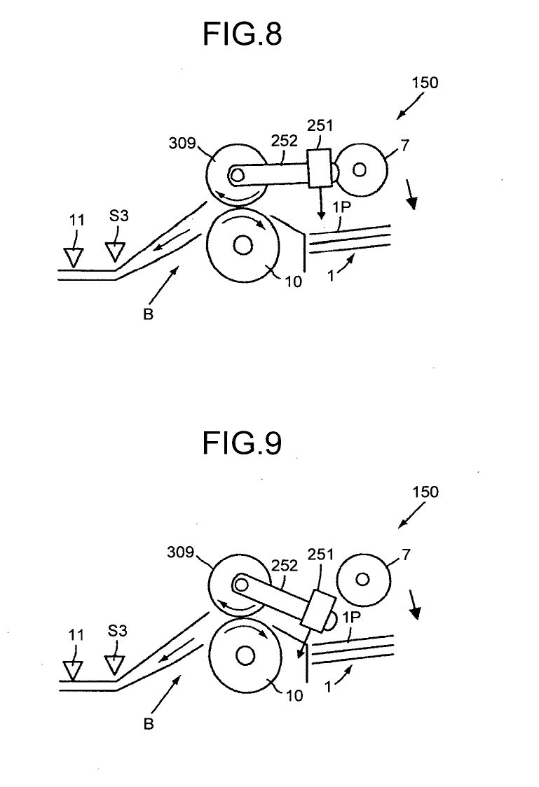

If, as illustrated in FIGS. 8 and 9, the sensor 251 is attached to an arm 252 that revolves with the axis of revolution being common with the axis of rotation of the feeding roller 309, the arm 252 is in a moved-up state as illustrated in FIG. 8 before the job starts; therefore, setting of originals is not prevented. If the sensor 251 is an optical sensor, by revolving the arm 252 to bring the sensor 251 close to the surface of the original that is conveyed, the light or the optical axis of the optical sensor can be made sufficiently oblique so as to increase the accuracy of the detection. If the sensor functioning as a detection unit is the mechanically-configured sensor 254 as illustrated in FIG. 10, similarly to the case when the optical sensor is used, setting of originals is not prevented before the job starts. After the job starts, a setting is made in which the sensor 254 presses against the surface of the original and accordingly movement of the original can be detected using the mechanical configuration. In other words, at least when the original stack 1 is being set on the sheet loading unit A, the sensor 251 or the sensor 254 is not in contact with an original 1P, which serves as a sheet. The arm 252 is driven by performing the processes included in the flowchart in FIG. 11.

The processes in the flowchart can be performed by, for example, the controller 110 or the control unit 111 of the main body. In FIG. 11, the arm 252 is arranged in a separated position from, and therefore not in contact with, the original 1P. It is then determined whether or not the original stack 1 or the original 1P is set on the original table 2 by on or off, respectively, of the setting sensor 5 of the original.

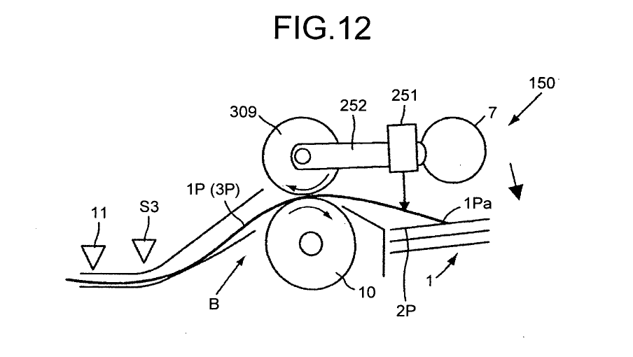

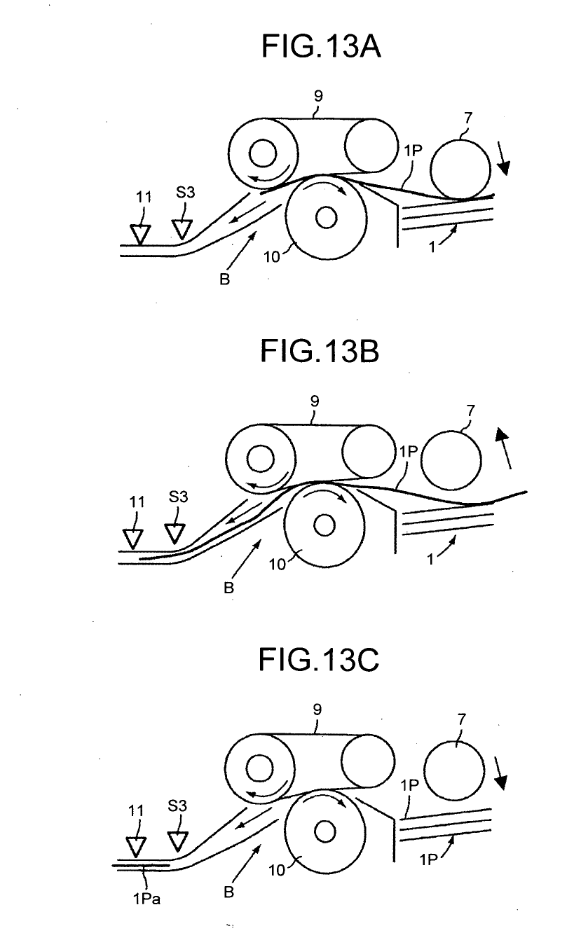

In the present embodiment, the sensor 251 is arranged in the upstream of the separation feeding unit B; therefore, for example, the trailing edge of the original 1P (sheet trailing edge) can be detected earlier by the sensor 251 can detect than by the separation sensor S3 arranged in the upstream of the abutting sensor 11. In the upstream of the separation feeding unit B, there may be originals that cannot be separated as indicated by the reference numeral 2P in FIG. 12. However, because the sensor 251 can detect the movement of the original 1P, the sensor 251 can distinguish the topmost original indicated by the reference numeral 3P in FIG. 12 from other originals 2P. Accordingly, the sensor 251 can prepare, with a quick timing and accuracy, for a pick-up operation (pick-up lowering) to be processed for the next original.

For this reason, it is desirable that the sensors 251 and 254 be arranged in the upstream of the separation feeding unit B and that the sensors 251 and 254 be arranged in the downstream of the pick-up roller 7 to reduce the influence of a flapping motion of the original 1P and to ensure the setting capability in setting the original 1P.

In the present embedment, because the sheet conveying device 150 is applied to the automatic document feeder 100 that is used for the image forming apparatus 200, the sheet member is described as the original 1P or the original stack 1. However, the range of applications of the sheet conveying device 150 is not limited to the above-described configurations. For example, instead of an original, a sheet member may be a recording medium S fed from the feeding unit 202. Thus, the configuration of the sheet conveying device 150 may be applied to a feeding device used for the feeding unit 202 or the feeding unit 203 that includes a bypass tray on which the recording medium S is manually set.

According to the present invention, the detection unit that is arranged near or in the upstream of the separation unit so as to detect the movement of an original is configured not to be in contact with a sheet at least when the stack of sheets is being set on a sheet loading unit; therefore, the trailing edge of the preceding original can be detected early. In addition, because the detection unit does not make contact with the sheet, the detection unit does not prevent sheet members from being set, so that the operability can be improved. Furthermore, because the detection unit has a function of detecting movement of a preceding original, the detection unit can detect whether there is a preceding original even when one sheet member overlaps with another sheet member. This improves the flexibility in arranging the detection unit for the preceding original and thus the productivity with a high-speed can be achieved using a more compact configuration. That is, while keeping the operability in setting originals and the like, the interval between originals can be set short so as to achieve high productivity.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A sheet conveying device comprising:
a sheet loading unit;
a pick-up roller that draws a sheet from a stack of sheets set on the sheet loading unit;
a moving unit that causes the pick-up roller to separate from or press against a top surface of the sheet;
a feeding member;
a prevention member that prevents a sheet from being conveyed by the feeding member;
a separation unit that separates and conveys each sheet, which is fed by the pick-up roller, to downstream in a conveying direction; and
a detection unit that detects whether the sheet moves, the detection unit being arranged in a position near the separation unit or in upstream of the separation unit in the conveying direction, wherein
at least when the stack of sheets is being set on the sheet loading unit, the detection unit is not in contact with the sheet.

2. The sheet conveying device according to claim 1, wherein the detection unit can detect movement of the sheet by using optical properties of the detection unit.

3. An original conveying device comprising the sheet conveying device according to claim 1.

4. A sheet scanning device comprising:
a scanning unit that scans an image on an original; and
an original conveying device that conveys the original to the scanning unit, wherein
a sheet scanning unit includes the original conveying device according to claim 3 as an original conveying device.

5. An image forming apparatus comprising the original conveying device according to claim 3.
